(19) United States
(12) Patent Application Publication
(10) Pub. No.: US 2008/0137607 A1
(43) Pub. Date: Jun. 12, 2008

(54) Method and System For Management of Handover Only Trunk Line Between Mobile Switching Centers For Handover in Mixed Mobile Communication System of an Asynchronous Network and a Synchronous Network

(75) Inventors: Jae-Yong Ju, Gyeonggi-do (KR); Sang-Yun Lee, Gyeonggi-do (KR); Hee-Hyeok Hahm, Seoul (KR); Young-Ho Joo, Gyeonggi-do (KR); Kyeong-Hee Han, Seoul (KR)

Correspondence Address: KELLEY DRYE & WARREN LLP, 3050 K STREET, NW, SUITE 400, WASHINGTON, DC, 20007, US

(73) Assignee: Sk Telecom Co., Ltd., Seoul (KR)

(21) Appl. No.: 10/591,943

(22) PCT Filed: Mar. 10, 2005
(86) PCT No.: PCT/KR05/00681

§ 371 Date: Oct. 23, 2007

(30) Foreign Application Priority Data
Mar. 10, 2004 (KR) 10-2004-0016292
Mar. 10, 2004 (KR) 10-2004-0016293

(51) Int. Cl. H04Q 7/00

(52) U.S. Cl. 370/331

(57) ABSTRACT

Disclosed are a method and a system for management of handover only trunk line between mobile switching centers for handover in a mixed mobile communication system of an asynchronous network and a synchronous network. The invention is performed to connect and disconnect a trunk line between asynchronous mobile switching centers and synchronous mobile switching centers, thereby sending and receiving of trunk line management messages wherein the message types are reset circuit message, blocking message, trunk test message and other additional types of message.

### TECHNICAL FIELD

The present invention relates to a method and system for management of a trunk line between mobile switching centers of an asynchronous network and a synchronous network and more particularly to a method and system for supporting maintenance and repair of a dedicated trunk line for handover between mobile switching centers in a hybrid mobile communication system including both an asynchronous network and a synchronous network.

### BACKGROUND ART

In current mobile communication networks, it is common that a synchronous mobile communication system (CDMA mobile communication system) called 2^{nd} or 2.5^{th} generation mobile communication system and an asynchronous mobile communication system (WCDMA mobile communication system) called 3^{rd} generation mobile communication system coexist. Therefore, mobile communication terminals (e.g. A Dual Band Dual Mode (DBDM) Terminal), which can be used in networks having such a construction, are now being developed.

The asynchronous mobile communication system is now in an initial stage of providing its service and requires an enormous investment for construction of the system. Therefore, the current asynchronous mobile communication system fails to provide service for a wide area and thus usually has a service area overlapping that of the synchronous mobile communication system. Due to such a limitation in the service area of the asynchronous mobile communication system, handover is necessary for continuous service provision when a subscriber of the asynchronous mobile communication system using the service of the asynchronous mobile communication system moves into an area of the synchronous mobile communication system which does not provide the asynchronous mobile communication service.

The handover between the asynchronous mobile communication system and the synchronous mobile communication system is achieved through exchange of messages between an asynchronous mobile switching center and a synchronous mobile switching center through a trunk line for handover. However, when the trunk line between the asynchronous mobile switching center and the synchronous mobile switching center fails to normally operate, error may occur during the handover, thereby interrupting the service provided to the mobile communication terminal moving from the asynchronous area to the synchronous area.

### DISCLOSURE OF INVENTION

### Technical Problem

Therefore, the present invention has been made in view of the above-mentioned problems, and it is an object of the present invention to provide a method and system for management of a dedicated trunk line for handover between an asynchronous mobile switching center and a synchronous network mobile switching center, which can prevent occurrence of error in the handover by periodically checking the status of the dedicated trunk line.

### Technical Solution

According to an aspect of the present invention, there is provided a method for management of a trunk line between an asynchronous mobile switching center and a synchronous mobile switching center for handover of a dual-band dual-mode mobile communication terminal capable of communicating with both an asynchronous mobile communication system and a synchronous mobile communication system, the method comprising the steps of: checking a status of the trunk line between the asynchronous mobile switching center and the synchronous mobile switching center by transmitting/receiving at least one of trunk line management messages between the asynchronous mobile switching center and the synchronous mobile switching center, when the asynchronous mobile switching center and the synchronous mobile switching center are in an invoke state, the trunk line management messages including a circuit reset message, a circuit interruption message and a trunk line test message.

In accordance with another aspect of the present invention, there is provided a method for management of a trunk line between an asynchronous mobile switching center and a synchronous mobile switching center for handover of a dual-band dual-mode mobile communication terminal capable of communicating with both an asynchronous mobile communication system and a synchronous mobile communication system, the method comprising the steps of: checking a status of the trunk line between the asynchronous mobile switching center and the synchronous mobile switching center by transmitting/receiving at least one of trunk line management messages through an interworking interoperability function unit between the asynchronous mobile switching center and the synchronous mobile switching center, the asynchronous mobile switching center and the synchronous mobile switching center being connected to the interworking interoperability function unit, the trunk line management messages including a circuit reset message, a circuit interruption message and a trunk line test message.

In accordance with still another aspect of the present invention, there is provided a system for management of a trunk line between an asynchronous mobile switching center and a synchronous mobile switching center for handover of a dual-band dual-mode mobile communication terminal in a hybrid mobile communication system including both an asynchronous network and a synchronous network, the system comprising: the asynchronous mobile switching center for transmitting a trunk line management message to the synchronous mobile switching center and receiving a response message from the synchronous mobile switching center, thereby confirming the status of the trunk line; and the synchronous mobile switching center for transmitting a trunk line management message to the synchronous mobile switching center and receiving a response message from the synchronous mobile switching center, thereby confirming the status of the trunk line.

### ADVANTAGEOUS EFFECTS

In a method and system according to the present invention, when a dual-mode dual-band mobile communication terminal moves from an area of an asynchronous mobile communication system to an area of a synchronous mobile communication system, trunk line management messages are transmitted/received between an asynchronous mobile switching center and a synchronous mobile switching center in performing the setting, resetting, releasing, retrial and status confirmation of the trunk line, in order to achieve an exact handover. Therefore, the present invention enables messages to be exactly transmitted between the asynchronous mobile switching center and the synchronous mobile switching center, thereby providing a service of an improved quality to a mobile communication terminal without interruption in the service.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram of a mobile communication network according to the first embodiment of the present invention;

FIG. 2 is a flowchart of a process for handover between an asynchronous network and a synchronous network according to the first embodiment of the present invention;

FIGS. 3 and 4 are views for describing the circuit reset message used in the method for managing a trunk line between mobile switching centers according to the first embodiment of the present invention;

FIGS. 5 through 8 are views for describing a circuit interruption message and a circuit interruption release message used in the method for managing a trunk line between mobile switching centers according to the first embodiment of the present invention;

FIGS. 9 through 11 are views for describing a trunk line test message (TrunkTest) used in the method for managing a trunk line between mobile switching centers according to the first embodiment of the present invention;

FIG. 12 is a block diagram of a mobile communication network according to the second embodiment of the present invention;

FIG. 13 is a flowchart of a process for handover between an asynchronous network and a synchronous network according to the second embodiment of the present invention;

FIGS. 14 and 15 are views for describing the circuit reset message used in the method for managing a trunk line between mobile switching centers according to the second embodiment of the present invention;

FIGS. 16 through 19 are views for describing a circuit interruption message and a circuit interruption release message used in the method for managing a trunk line between mobile switching centers according to the second embodiment of the present invention; and

FIGS. 20 through 22 are views for describing a trunk line test message used in the method for managing a trunk line between mobile switching centers according to the second embodiment of the present invention.

### BEST MODE FOR CARRYING OUT THE INVENTION

Reference will now be made in detail to the preferred embodiments of the present invention.

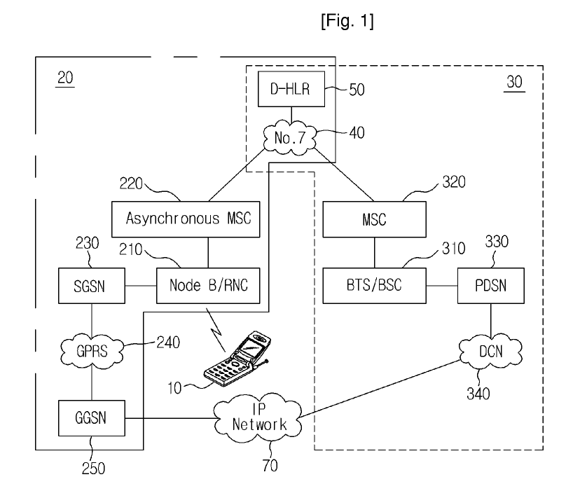

Hereinafter, a method and system for management of a dedicated handover trunk line between mobile switching centers in a hybrid mobile communication system including both an asynchronous network and a synchronous network according to the first embodiment of the present invention will be described with reference to FIGS. 1 through 6.

First, FIG. 1 is a block diagram of a mobile communication network according to the first embodiment of the present invention.

Referring to FIG. 1, a mobile communication terminal 10 according to the first embodiment of the present invention is a Dual-Band Dual-Mode (DBDM) mobile communication terminal capable of supporting both the asynchronous mobile communication service and the synchronous mobile communication service and includes a synchronous modem for the synchronous mobile communication service, an asynchronous modem for the asynchronous mobile communication service, and a common module. Therefore, the mobile communication terminal 10 can connect with either an asynchronous mobile communication system 20 or a synchronous mobile communication system 30 in order to use voice and data service provided by them.

The asynchronous mobile communication system 20 includes a node B/RNC 210, an asynchronous mobile switching center (MSC) 220, a General Packet Radio Service (GPRS) network 240, a serving GPRS Support Node (SGSN) 230, and a Gateway GPRS Support Node (GGSN) 250. The node B/RNC 210 represents a node B serving as a base station for supporting wireless communication with the mobile communication terminal 10 or an RNC (Radio Network Controller) 210 for controlling the node B for wireless communication with the mobile communication terminal 10. The asynchronous mobile switching center 220 is connected to the node B/RNC 210 and performs call exchange with the mobile communication terminal 10 through the node B/RNC 210 in order to provide service to the mobile communication terminal 10. The SGSN 230 is connected between the node B/RNC 210 and the GPRS network 240 to keep tracking the position of the mobile communication terminal 10 and perform an access control and a security function. The GGSN 250 is connected to the SGSN 230 through the GPRS network 240 and to an IP network 70 to support inter-working with outer systems for exchange of packet.

The synchronous mobile communication system 30 includes a BTS/BSC 310, a synchronous mobile switching center 320, a PDSN 330, and a Data Core Network (DCN) 340. The BTS/BSC 310 represents a BTS (Base Transceiver Station) for supporting wireless communication with the mobile communication terminal 10 or a BSC (Base Station Controller) for controlling the BTS for wireless communication with the mobile communication terminal 10. The synchronous mobile switching center 320 is connected to and exchanges calls with at least one BSC. The PDSN 330 is connected to the BSC to provide a packet data service to subscribers. The DCN 340 supports connection between the PDSN 330 and the IP network 70.

The asynchronous mobile switching center 220 and the synchronous mobile switching center 320 are interconnected through a No. 7 common signal network 40 and are connected to a Dual stack Home Location Register (D-HLR) 50 through the No. 7 common signal network 40. The Dual stack Home Location Register 50 stores and manages asynchronous mobile communication system subscriber information of the DBDM mobile communication terminal 10 and corresponding synchronous mobile communication system subscriber information, so that the asynchronous mobile switching center 220 and the synchronous mobile switching center 320 can refer to the information when performing works such as handover.

In the network having the construction described above, the mobile communication terminal 10 located within the area of the asynchronous mobile communication system 20 periodically measures the intensity of the signal from a serving node B to which the mobile communication terminal 10 is currently connected and the intensity of the signal from neighbor node Bs adjacent to the serving node B and reports the measured intensities to the serving node B. When the intensity of the signal from the serving node B lowers below a predetermined threshold value, the serving node B reports occurrence of handover event to the asynchronous mobile switching center 220 through the RNC. In this case, the node B/RNC 210 transmits to the asynchronous mobile switching center 220 the report together with information of neighbor cells, base station IDs, etc., which have been detected by the mobile communication terminal 10.

Upon receiving a handover request message from the RNC, the asynchronous mobile switching center 220 determines with reference to the neighbor cells, base station IDs, etc., received from the RNC if the requested handover is handover between neighbor cells within the asynchronous mobile communication system 20 or handover to the synchronous mobile communication system 30. When the requested handover is handover between neighbor cells, the asynchronous mobile switching center 220 performs the handover between neighbor cells. In contrast, when the requested handover is handover to the synchronous mobile communication system 30, the asynchronous mobile switching center 220 inter-operates with the synchronous mobile switching center 320 to perform the handover to the synchronous mobile communication system 30.

Hereinafter, a process of the handover will be described in detail with reference to FIG. 2.

FIG. 2 is a flowchart of a process for handover between an asynchronous network and a synchronous network according to the first embodiment of the present invention.

Referring to FIG. 2, as the mobile communication terminal 10 performing voice communication in the area of the asynchronous mobile communication system 20 moves to the area of the synchronous mobile communication system 30, the mobile communication terminal 10 detects a signal from the synchronous mobile communication system 30, periodically measures the intensities of the signals from a current serving node B of the asynchronous mobile communication system 20 and neighbor base stations (node Bs), and reports the measured intensities to the current serving node B. When the intensity of the signal from the current serving node B to which the mobile communication terminal 10 currently connects is lower than a pre-determined value, the mobile communication terminal 10 transmits a handover request message (IU-Reloc Required) to the asynchronous mobile switching center 220 through the RNC (step S101).

This handover request message (IU Reloc Required) includes a handover-related message used in the synchronous mobile communication system. Here, the RNC transmits to the asynchronous mobile switching center 220, together with the handover request message, neighbor cell information, neighbor base station information (neighbor Bs IDs), etc., which have been received from the mobile communication terminal 10. Based on this information, the asynchronous mobile switching center 220 determines if the requested handover is handover between neighbor cells within the asynchronous mobile communication system 20 or handover to the synchronous mobile communication system 30.

Upon receiving the handover request message, the asynchronous mobile switching center 220 transmits a handover instruction message (Facilities Directive2) to the synchronous mobile switching center 320 (step S102). Then, the synchronous mobile switching center 320 transmits a handover request message (Handoff Request) to the BTS/BSC 310 (step S103).

Before transmitting the handover instruction message (Facilities Directive2) to the synchronous mobile switching center 320, the asynchronous mobile switching center 220 produces a billing identifier (ID) and inserts it in the handover instruction message (Facilities Directive2). Also, the asynchronous mobile switching center 220 inserts an internal switching center circuit ID (InterMSCCircuitID) corresponding to each handover zone into the transmitted handover instruction message (Facilities Directive2). The billing ID includes an ID of the synchronous mobile switching center 320 to which the asynchronous mobile switching center 220 will connect.

Upon receiving the handover request message from the synchronous mobile switching center 320, the BTS/BSC 310 transmits null frames (null Forward Traffic Channel frames) through a downlink traffic channel to the synchronous modem of the mobile communication terminal 10, thereby enabling assignment of a downlink channel (step S104). Then, the BTS/BSC 310 transmits to the synchronous mobile switching center 320 a response message (Handoff Request Ack) in response to the handover request message from the synchronous mobile switching center 320 (step S105). Then, the synchronous mobile switching center 320 transmits to the asynchronous mobile switching center 220 a response message (Facilities Directive2 Ack) in response to the handover instruction message from the asynchronous mobile switching center 220 (step S106). As a result, a trunk line between the asynchronous mobile switching center 220 and the synchronous mobile switching center 320 is established.

To be more specific, the asynchronous mobile switching center 220 sets a mapping relation between a physical trunk line and a dedicated channel which is an identifier for logical trunk line establishment, sets this information as the internal switching center circuit ID (InterMSCCircuitID) of the handover instruction message (Facilities Directive2), and transmits the set ID to the synchronous mobile switching center 320.

Thereafter, when the response message (Facilities Directive2 Ack) has been transmitted from the synchronous mobile switching center 320, the trunk line between the asynchronous mobile switching center 220 and the synchronous mobile switching center 320 is established. The handover instruction message (Facilities Directive2) transmitted between the asynchronous mobile switching center 220 and the synchronous mobile switching center 320 includes parameters such as a billing ID, an ESN, an internal switching center circuit ID and MIN, and the response message (Facilities Directive2 Ack) thereof includes parameters such as CDMA channel data and a CDMA channel list.

After the trunk line between switching centers is set in the way as described above, the asynchronous mobile switching center 220 reports to the node B/RNC 210 that resource allocation for the handover has been completed (IU Relocation Command) (step S107). Upon receiving the report (IU Relocation Command), the node B/RNC 210 instructs the asynchronous modem of the mobile communication terminal 10 to perform handover (Handover from UTRAN command) (step S108).

Thereafter, the asynchronous modem of the mobile communication terminal 10 transmits channel assignment information (Channel Assignment) to the synchronous modem (step S109). The synchronous modem of the mobile communication terminal 10 transmits frames or preambles (Reverse Traffic Channel Frames or Traffic Channel Preambles) through an uplink traffic channel to the BTS/BSC 310 of the synchronous mobile communication system (step S110) and reports (Handoff Completion Message) that the handover has been completed (step S111). Upon receiving the report (Handoff Completion Message), the BTS/BSC 310 transmits a response signal (BS Ack Order) in response to the report (step S112). Then, the synchronous modem reports to the asynchronous modem that the call connection with the synchronous mobile communication system has been completely established (step S113).

Meanwhile, the BTS/BSC 310 reports to the synchronous mobile switching center 320 (Handoff Complete) that the handover has been completed (step S114), and the synchronous mobile switching center 320 reports to the asynchronous mobile switching center 220 (Mobile On Channel) that the handover has been completed (step S115). Next, the asynchronous mobile switching center 220 requests the node B/RNC 210 (IU Release Command) to release the connection (step S116). When the asynchronous mobile switching center 220 receives a response (IU Release Complete) to the release request, the connection between the asynchronous mobile switching center 220 and the node B/RNC 210 is released (step S117).

After the handover for the mobile communication terminal performing voice communication in the area of the asynchronous mobile communication system into the synchronous mobile communication system has been completed according to the process described above, the call connection is released by a request from one of the two mobile communication terminals (Facilities Release, Facilities Ack) (step S118).

It is possible to perform the handover process as described above when the messages are exactly exchanged without errors between the synchronous mobile switching center and the asynchronous mobile switching center. In other words, the synchronous mobile switching center and the asynchronous mobile switching center are interconnected through a dedicated trunk line for handover, and it is possible to provide a high quality service to subscribers when the trunk line exactly operates without error.

In order to check if the trunk line exactly operates without error, the synchronous mobile switching center and the asynchronous mobile switching center use a circuit reset message (ResetCircuit), a circuit interruption message (Blocking), a circuit interruption release message, a trunk line test message (TrunkTest), and a trunk line test release message. Those messages enumerated above will be referred to as ‘trunk line management messages’ in the present invention. After the asynchronous mobile switching center or the synchronous mobile switching center responds to a paging from the counterpart mobile switching center, it transmits a trunk line management message to the counterpart mobile switching center and then receives a response to the trunk line management message. Then, the status of the trunk line can be confirmed.

In other words, either of the asynchronous mobile switching center and the synchronous mobile switching center can first transmit a trunk line management message to the counterpart when it is in an invoke state, and the counterpart transmits a response to the received trunk line management message. Then, the mobile switching center first transmitted the trunk line management message can confirm the status of the trunk line.

FIGS. 3 through 11 are views for illustrating a method for confirming a status of a dedicated handover trunk line between mobile switching centers by transmitting/receiving trunk line management messages and for showing lists of parameters included in each of the trunk line management messages. In the present embodiment, a case where an asynchronous mobile switching center first transmits a trunk line management message to a synchronous mobile switching center and the synchronous mobile switching center then transmits a response to the received trunk line management message will be discussed as an example.

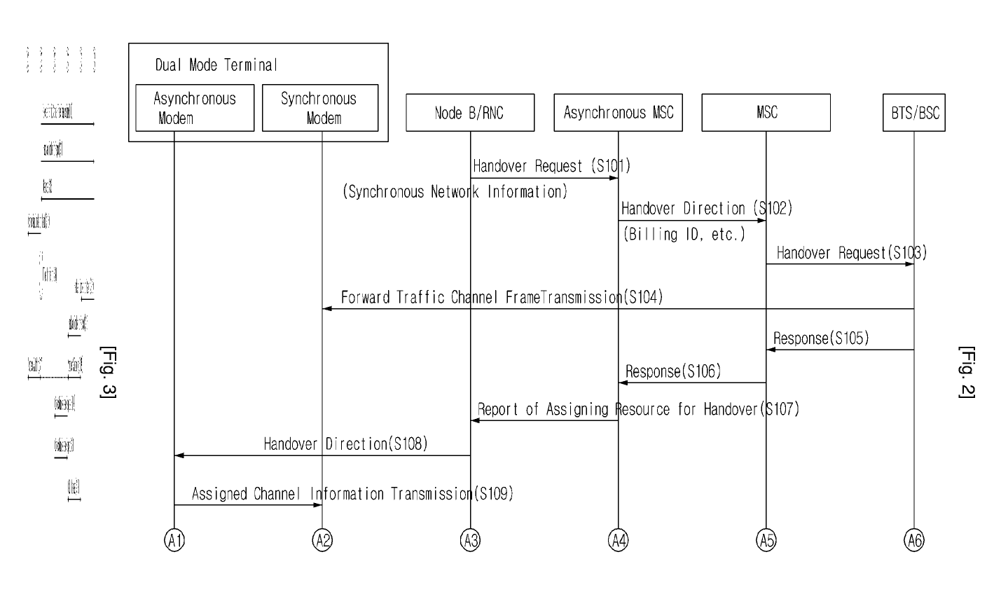

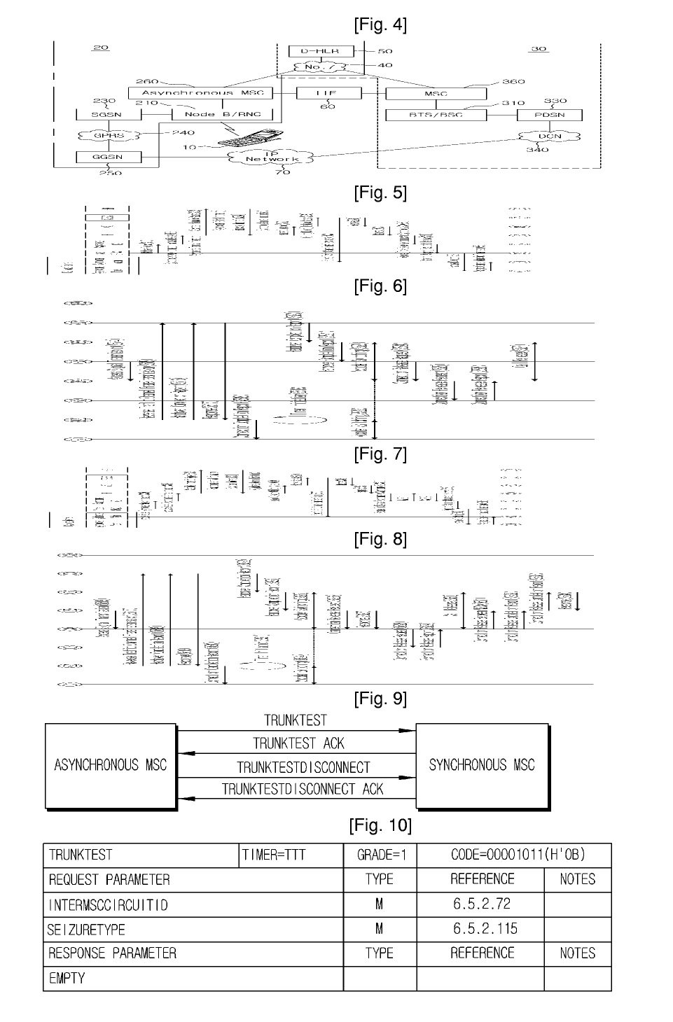

FIGS. 3 and 4 are views for describing the circuit reset message (ResetCircuit) used in the method for managing a trunk line between mobile switching centers according to the first embodiment of the present invention. As shown in FIG. 3, the asynchronous mobile switching center uses the circuit reset message (ResetCircuit) when it is necessary to use a trunk line between the asynchronous mobile switching center and the synchronous mobile switching center or in order to reproduce status information of a damaged circuit and reset the damaged circuit. Upon receiving the circuit reset message (ResetCircuit), the synchronous mobile switching center transmits a response message (ResetCircuit Ack) including the status information of the trunk line to the asynchronous mobile switching center.

The circuit reset message (ResetCircuit) includes a parameter (InterMSCCircuitID) for the internal switching center circuit ID as shown in FIG. 4 and the response message (ResetCircuit Ack) includes a parameter (TrunkState) for the status information of trunk line.

FIGS. 5 through 8 are views for describing a circuit interruption message (Blocking) and a circuit interruption release message used in the method for managing a trunk line between mobile switching centers according to the first embodiment of the present invention.

Referring to FIG. 5, in order to report that the trunk line allocated between the mobile switching centers has been interrupted, that is, when it is unnecessary to maintain the connection between the mobile switching centers any more, the asynchronous mobile switching center transmits a circuit interruption message (Blocking) to the synchronous mobile switching center and the synchronous mobile switching center transmits a response message (Blocking Ack) to the asynchronous mobile switching center.

Referring to FIG. 7, when the connection between the mobile switching centers has been interrupted by the circuit interruption message (Blocking), the asynchronous mobile switching center transmits a circuit reset message (Unblocking) to the synchronous mobile switching center in order to switch the trunk line into a serviceable status and the synchronous mobile switching center transmits a response message (Unblocking Ack) to the circuit reset message (Unblocking).

The circuit interruption message (Blocking) includes a parameter (InterMSCCircuitID) for the internal switching center circuit ID as shown in FIG. 6 and the circuit reset message (Unblocking) also includes a parameter (InterMSCCircuitID) for the internal switching center circuit ID as shown in FIG. 8.

FIGS. 9 through 11 are views for describing a trunk line test message (TrunkTest) used in the method for managing a trunk line between mobile switching centers according to the first embodiment of the present invention.

As shown in FIG. 9, in order to check if the trunk line exactly operates, the asynchronous mobile switching center transmits a trunk line test message (TrunkTest) to the synchronous mobile switching center and the synchronous mobile switching center transmits a response message (TrunkTest Ack) to the asynchronous mobile switching center.

When it is necessary to end the test for the trunk line, the asynchronous mobile switching center transmits a trunk line test release message (TrunkTestDisconnect) to the synchronous mobile switching center and the synchronous mobile switching center transmits a response message (TrunkTestDisconnect Ack) to the asynchronous mobile switching center.

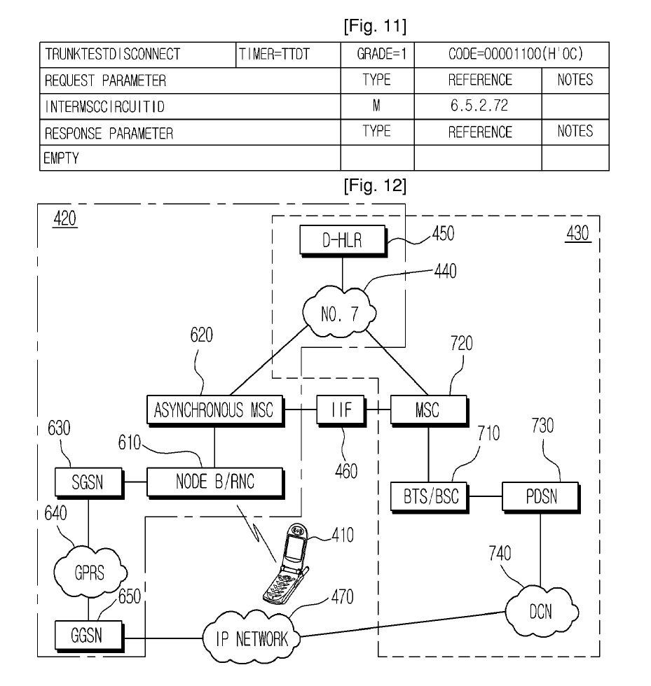

The trunk line test message (TrunkTest) includes parameters for the internal switching center circuit ID (InterMSCCircuitID) and the seizure type (SeizureType) as shown in FIG. 10 and the trunk line test release message (TrunkTestDisconnect) includes a parameter for the internal switching center circuit ID (InterMSCCircuitID) as shown in FIG. 11.

The above description deals with the case where the trunk line management messages are first transmitted from the asynchronous mobile switching center to the synchronous mobile switching center by using the MAP protocol. However, it is possible to manage the trunk line in the opposite manner in which the synchronous mobile switching center first transmits the trunk line management messages to and then receives response messages from the synchronous mobile switching center. Further, each of the trunk line management messages may include other parameters in addition to the parameters shown in the drawings according to expansion of functions performed between the mobile switching centers.

Hereinafter, a method and system for management of a dedicated handover trunk line between mobile switching centers in a hybrid mobile communication system including both an asynchronous network and a synchronous network according to the second embodiment of the present invention will be described with reference to FIGS. 12 through 22.

FIG. 12 is a block diagram of a mobile communication network according to the second embodiment of the present invention.

Referring to FIG. 12, a mobile communication terminal 410 according to the second embodiment of the present invention is a Dual-Band Dual-Mode (DBDM) mobile communication terminal capable of supporting both the asynchronous mobile communication service and the synchronous mobile communication service and includes a synchronous modem for the synchronous mobile communication service, an asynchronous modem for the asynchronous mobile communication service, and a common module. Therefore, the mobile communication terminal 410 can connect with either an asynchronous mobile communication system 420 or a synchronous mobile communication system 430 in order to use voice and data service provided by them.

The asynchronous mobile communication system 420 includes a node B/RNC 610, an asynchronous mobile switching center (MSC) 620, a General Packet Radio Service (GPRS) network 640, a serving GPRS Support Node (SGSN) 630, and a Gateway GPRS Support Node (GGSN) 650. The node B/RNC 610 represents a node B serving as a base station for supporting wireless communication with the mobile communication terminal 410 or an RNC (Radio Network Controller) 610 for controlling the node B for wireless communication with the mobile communication terminal 410. The asynchronous mobile switching center 620 is connected to the node B/RNC 610 and performs call exchange with the mobile communication terminal 410 through the node B/RNC 610 in order to provide service to the mobile communication terminal 410. The SGSN 630 is connected between the node B/RNC 610 and the GPRS network 640 to keep tracking the position of the mobile communication terminal 410 and perform an access control and a security function. The GGSN 650 is connected to the SGSN 630 through the GPRS network 640 and to an IP network 470 to support inter-working with outer systems for exchange of packet.

The synchronous mobile communication system 430 includes a BTS/BSC 710, a synchronous mobile switching center (MSC) 720, a PDSN 730, and a Data Core Network (DCN) 740. The BTS/BSC 710 represents a BTS (Base Transceiver Station) for supporting wireless communication with the mobile communication terminal 410 or a BSC (Base Station Controller) for controlling the BTS for wireless communication with the mobile communication terminal 410. The synchronous mobile switching center 720 is connected to and exchanges calls with at least one BSC. The PDSN 730 is connected to the BSC to provide a packet data service to subscribers. The DCN 740 supports connection between the PDSN 730 and the IP network 470.

Further, the mobile switching centers 620 and 720 of the asynchronous mobile communication system 420 and the synchronous mobile communication system 430 are interconnected through an Interworking Interoperability Function (IIF) unit 460. The IIF unit 460 receives an asynchronous message from the asynchronous mobile switching center 620, converts the received asynchronous message to a synchronous message, and then transmits the converted synchronous message to the synchronous mobile switching center 720. Also, the IIF unit 460 constructs and manages a database for the synchronous mobile communication system information.

The asynchronous mobile switching center 620 and the synchronous mobile switching center 720 are interconnected through a No. 7 common signal network 440 and are connected to a Dual stack Home Location Register (D-HLR) 450 through the No. 7 common signal network 440. The Dual stack Home Location Register 450 stores and manages asynchronous mobile communication system subscriber information of the DBDM mobile communication terminal 410 and corresponding synchronous mobile communication system subscriber information, so that the asynchronous mobile switching center 620 and the synchronous mobile switching center 720 can refer to the information when performing works such as handover.

In the network having the construction described above, the mobile communication terminal 410 located within the area of the asynchronous mobile communication system 420 periodically measures the intensity of the signal from a serving node B to which the mobile communication terminal 410 is currently connected and the intensity of the signal from neighbor node Bs adjacent to the serving node B and reports the measured intensities to the serving node B. When the intensity of the signal from the serving node B lowers below a predetermined threshold value, the serving node B reports occurrence of handover event to the asynchronous mobile switching center 620 through the RNC. In this case, the node B/RNC 610 transmits to the asynchronous mobile switching center 620 the report together with information of neighbor cells, base station IDs, etc., which have been detected by the mobile communication terminal 410.

Upon receiving a handover request message from the RNC, the asynchronous mobile switching center 620 determines with reference to the neighbor cells, base station IDs, etc., received from the RNC if the requested handover is handover between neighbor cells within the asynchronous mobile communication system 420 or handover to the synchronous mobile communication system 430.

When the requested handover is handover between neighbor cells within the asynchronous mobile communication system 420, the asynchronous mobile switching center 620 performs the handover between neighbor cells. In contrast, when the requested handover is handover to the synchronous mobile communication system 430, the asynchronous mobile switching center 620 causes the IIF unit 460 to perform the handover to the synchronous mobile communication system 430. For the handover, the IIF unit 460 converts an asynchronous message to a synchronous message and transmits the converted synchronous message to the synchronous mobile switching center 720. For this operation, it is necessary for the IIF unit 460 to construct and manage a database of the synchronous mobile communication system information in advance. The database includes information of switching centers, signal point, information of the trunk line in relation to a dedicated channel, etc. Based on the synchronous mobile communication system information and the handover request from the asynchronous mobile switching center 620, the IIF unit 460 selects the target to be handovered, that is, the mobile switching center 620, and generates a billing ID including an ID of the handover target mobile switching center, which can be used in the handover process thereafter.

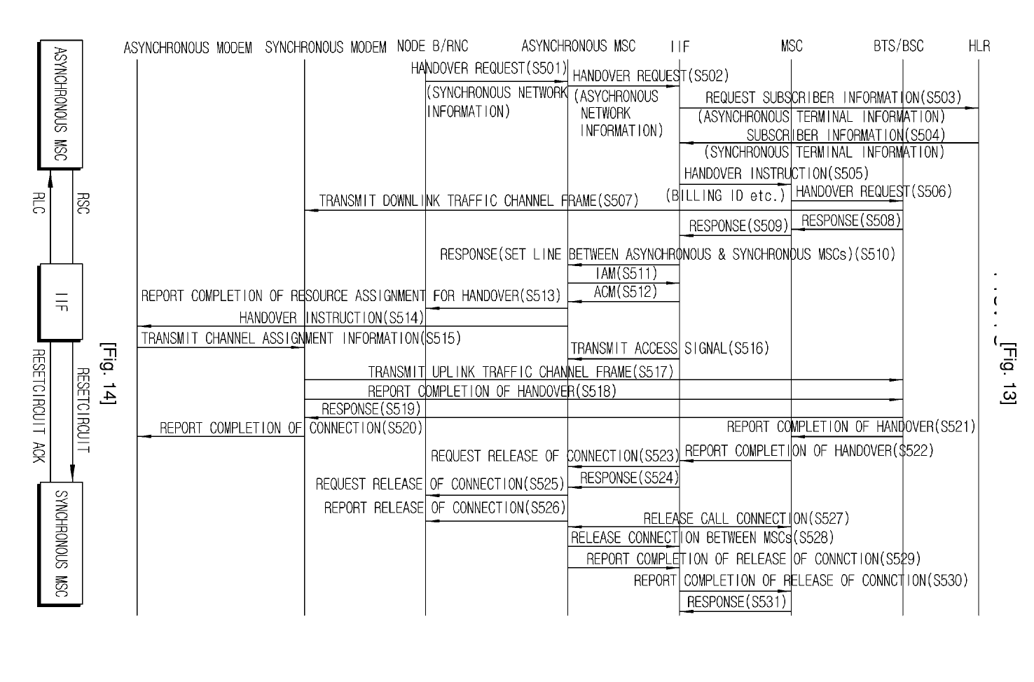

Hereinafter, a process of the handover will be described in detail with reference to FIG. 13.

FIG. 13 is a flowchart of a process for handover between an asynchronous network and a synchronous network according to the second embodiment of the present invention.

Referring to FIG. 13, as the mobile communication terminal 410 performing voice communication in the area of the asynchronous mobile communication system 420 moves to the area of the synchronous mobile communication system 430, the mobile communication terminal 410 detects a signal from the synchronous mobile communication system 430, periodically measures the intensities of the signals from a current serving node B of the asynchronous mobile communication system 420 and neighbor base stations (node Bs), and reports the measured intensities to the current serving node B. When the intensity of the signal from the current serving node B to which the mobile communication terminal 410 currently connects is lower than a pre-determined value, the mobile communication terminal 410 transmits a handover request message (IU-Reloc Required) to the asynchronous mobile switching center 620 through the RNC (step S501).

This handover request message (IU Reloc Required) includes a handover-related message used in the synchronous mobile communication system. Here, the RNC transmits to the asynchronous mobile switching center 620, together with the handover request message, neighbor cell information, neighbor base station information (neighbor BS IDs), etc., which have been received from the mobile communication terminal 410. Based on this information, the asynchronous mobile switching center 620 determines if the requested handover is handover between neighbor cells within the asynchronous mobile communication system 420 or handover to the synchronous mobile communication system 430. The handover request message (IU Reloc Required) transmitted from the RNC to the asynchronous mobile switching center 620 includes parameters such as message type, handover type, handover cause, source base station controller ID, target base station controller ID, Radio Access Bearer (RAB) information and wireless zone-related information. Further, the RNC adds the handover-related information used in the synchronous mobile communication system to the parameter of ‘Old BSS To New BSS Information’ included in the handover request message.

Upon receiving the handover request message, the asynchronous mobile switching center 620 transmits an asynchronous message (MAP Prep Handover Req) requesting handover to the IIF unit 460 (step S502). Here, an extension container is added to the asynchronous message, which is then transmitted together with an asynchronous identifier (MSISDN) of the mobile communication terminal 410. The asynchronous message includes parameters such as an invoke ID, a target cell ID, a target radio network controller ID, and an MSISDN.

Thereafter, by referring to received asynchronous subscriber information (MSISDN) from the asynchronous mobile switching center 220, the IIF unit 460 requests the D-HLR 450 to transmit subscriber information (Call Data Request) (step S503). That is, the IIF unit 460 requests a synchronous network identifier (MIN, ESN) of the mobile communication terminal 410. In step S503, the IIF unit 460 may request synchronous network identifier information of a subscriber to the D-HLR 450 by using an asynchronous message (MAP_SEND_IMSI).

Upon receiving the request for the subscriber information, the D-HLR 450 refers to the database, extracts synchronous network identifier information (MIN, ESN) of the corresponding subscriber, and then transmits the extracted information to the IIF unit 460 (Call Data Req Ack) (step S504). Here, the synchronous network message (Call Data Request) requesting the synchronous network identifier information of the subscriber includes parameters such as the billing ID and digits (i.e. MSISDN) and the response message (Call Data Req Ack) includes parameters such as ESN, MIN, and MSCID. Meanwhile, when an asynchronous message (MAP_SEND_IMSI) is used in requesting the synchronous network identifier information of the subscriber, the asynchronous message (MAP_SEND_IMSI) includes parameters such as an invoke ID, MSISDN, IMSI, and ESN.

Upon receiving the subscriber information from the D-HLR 450, the IIF 460 instructs (Facilities Directive2) the handover to the synchronous mobile switching center 720 (step S505), and the synchronous mobile switching center 720 transmits a handover request message (Handoff Request) to the BTS/BSC 710 (step S506).

Before transmitting the handover instruction message (Facilities Directive2) to the synchronous mobile switching center 720, the IIF unit 460 produces a billing identifier (ID) and inserts it in the handover instruction message (Facilities Directive2). Also, the IIF unit 460 inserts the internal switching center circuit ID (InterMSCCircuitID) into the transmitted handover instruction message (Facilities Directive2). The billing ID includes an ID of the synchronous mobile switching center 720 to which the asynchronous mobile switching center 620 will connect.

Upon receiving the handover request message from the synchronous mobile switching center 720, the BTS/BSC 710 transmits null frames (Forward Traffic Channel frames) through a downlink traffic channel to the synchronous modem of the mobile communication terminal 410, thereby enabling assignment of a downlink channel (step S507). Then, the BTS/BSC 710 transmits to the synchronous mobile switching center 720 a response message (Handoff Request Ack) in response to the handover request message from the synchronous mobile switching center 720 (step S508). Then, the synchronous mobile switching center 720 transmits to the asynchronous mobile switching center 620 a response message (Facilities Directive2 Ack) in response to the handover instruction message of step S502 (step S509). As a result, a trunk line between the asynchronous mobile switching center 620 and the synchronous mobile switching center 720 is established.

To be more specific, the IIF unit 460 sets a mapping relation between a physical trunk line and a dedicated channel which is an identifier for logical trunk line establishment, sets this information as the internal switching center circuit ID (InterMSCCircuitID) of the handover instruction message (Facilities Directive2), and transmits the set ID to the synchronous mobile switching center 720. Thereafter, when the response message (Facilities Directive2 Ack) has been transmitted from the synchronous mobile switching center 720, the trunk line between the asynchronous mobile switching center 620 and the synchronous mobile switching center 720 is established. The handover instruction message (Facilities Directive2) transmitted between the asynchronous mobile switching center 620 and the synchronous mobile switching center 720 includes parameters such as a billing ID, an ESN, an internal switching center circuit ID and MIN, and the response message (Facilities Directive2 Ack) thereof includes parameters such as CDMA channel data and a CDMA channel list.

Thereafter, the asynchronous mobile switching center 620 transmits an Initial Address Message (IAM) to the IIF unit 460, and the IIF unit 460 transmits an Address Completion Message (ACM) in response to the LAM, so that the trunk line is set between the asynchronous mobile switching center 620 and the synchronous mobile switching center 720 and the call can be routed through the trunk line (step S511 and S512). Messages for the trunk setting between the mobile switching centers are transmitted/received by the ISUP.

After the trunk line between switching centers is set in the way as described above, the asynchronous mobile switching center 620 reports to the node B/RNC 610 that resource allocation for the handover has been completed (IU Relocation Command) (step S513). Upon receiving the report (IU Relocation Command), the node B/RNC 610 requests the asynchronous modem of the mobile communication terminal 410 to perform handover (Handover from UTRAN command) (step S514). Here, the message (IU Relocation Command) reporting that resource allocation for the handover has been completed includes parameters including the message type, the RRC container, the RAB list to be released, etc.

Thereafter, the asynchronous modem of the mobile communication terminal 410 transmits channel assignment information to the synchronous modem (step S515) and the IIF unit 460 requests an access signal (MAP Process Access Signaling Req) to the asynchronous mobile switching center 620 (step S516). The access signal contains an invoke ID, an Application Protocol Data Unit (APDU), selected radio resource information, etc.

Further, the synchronous modem of the mobile communication terminal 410 transmits frames or preambles through an uplink traffic channel to the BTS/BSC 710 of the synchronous mobile communication system (step S517) and reports (Handoff Completion Message) that the handover has been completed (step S518). Upon receiving the report (Handoff Completion Message), the BTS/BSC 710 transmits a response signal (BS Ack Order) in response to the report (step S519). Then, the synchronous modem reports to the asynchronous modem that the call connection with the synchronous mobile communication system has been completely established (step S520).

Then, the BTS/BSC 710 reports to the synchronous mobile switching center 720 (Handoff Complete) that the handover has been completed (step S521), and the synchronous mobile switching center 720 reports to the IIF unit 460 (Mobile On Channel) that the handover has been completed (step S522). Upon receiving the report, the IIF unit 460 requests the asynchronous mobile switching center 620 to release the connection (MAP Send End Signal Req) (step S523).

Further, the IIF unit 460 transmits to the asynchronous mobile switching center 620 a message (ANSWER) reporting the connection between the mobile communication terminal and the synchronous mobile switching center 720 (step S524). Then, the connection between the asynchronous mobile switching center 620 and the node B/RNC 610 is released (IU Release Command, IU Release Complete) (steps 525 and 526).

A process of releasing the call connection after the handover of the mobile communication terminal performing voice communication in the area of the asynchronous mobile communication system into the synchronous mobile communication system has been completed according to the process described above will be briefly discussed below. The release of the call connection may be first requested by either a mobile communication terminal of a subscriber still located within the area of the asynchronous mobile communication system or a mobile communication terminal of a subscriber already handovered to the area of the synchronous mobile communication system. In the present embodiment, description is given of the case where the release of the call connection has been requested by the mobile communication terminal of the subscriber still located within the area of the asynchronous mobile communication system.

As the mobile communication terminal releases the call, the call connection between the asynchronous mobile switching center 620 and the synchronous mobile switching center 720 is released (Call Release) (step S527) and the trunk connection between the mobile switching centers is released (Release) (step S528). Thereafter, the asynchronous mobile switching center 620 reports to the IIF unit 460 that the release of the connection has been completed (MAP Send End Signal Resp) (step S529), and the IIF unit 460 transmits a call release request message (Facilities Release) to the synchronous mobile switching center 720 (step S530). When the synchronous mobile switching center 720 receives a response (Facilities Ack) to the request message, the trunk line set between the mobile switching centers is released (step S531). Here, the call release request message (Facilities Release) includes parameters including an internal MSC circuit ID, a release reason, a billing ID, MIN, etc., and the response message (Facilities Ack) includes parameters including a billing ID, etc.

It is possible to perform the handover process as described above when the messages are exactly exchanged without errors between the synchronous mobile switching center and the asynchronous mobile switching center. In other words, the synchronous mobile switching center and the asynchronous mobile switching center are interconnected through an interworking interoperability function unit and a dedicated trunk line for handover, and it is possible to provide a high quality service to subscribers when the trunk line exactly operates without error.

In order to check if the trunk line exactly operates without error, the synchronous mobile switching center and the asynchronous mobile switching center use a circuit reset message, a circuit interruption message, a circuit interruption release message, a trunk line test message, and a trunk line test release message. After the asynchronous mobile switching center or the synchronous mobile switching center responds to a paging from the counterpart mobile switching center, it transmits a trunk line management message to the counterpart mobile switching center and then receives a response to the trunk line management message. Then, the status of the trunk line can be confirmed.

In other words, either of the asynchronous mobile switching center and the synchronous mobile switching center can first transmit a trunk line management message to the counterpart when it is in an invoke state, and the counterpart transmits a response to the received trunk line management message. Then, the mobile switching center first transmitted the trunk line management message can confirm the status of the trunk line.

If the asynchronous mobile switching center transmits an ISUP protocol-based trunk line management message to the IIF unit, the IIF unit converts the received message into an MAP protocol-based trunk line management message and then transmits the converted message to the synchronous mobile switching center. In contrast, if the synchronous mobile switching center transmits an MAP protocol-based trunk line management message to the IIF unit, the IIF unit converts the received message into an ISUP protocol-based trunk line management message and then transmits the converted message to the asynchronous mobile switching center.

FIGS. 14 through 22 are views for illustrating a method for confirming a status of a dedicated handover trunk line between mobile switching centers by transmitting/receiving trunk line management messages according to the second embodiment of the present invention and for showing lists of parameters included in each of the trunk line management messages. In the present embodiment, the following case will be discussed as an example: an asynchronous mobile switching center first transmits a trunk line management message to an IIF unit by using an ISUP protocol, the IIF unit converts the trunk line management message by using an MAP protocol and transmits the converted message to the synchronous mobile switching center, the synchronous mobile switching center transmits a response message to the IIF unit by using the MAP protocol, and the IIF unit converts the response message by using the ISUP protocol and then transmits the converted response message to the asynchronous mobile switching center.

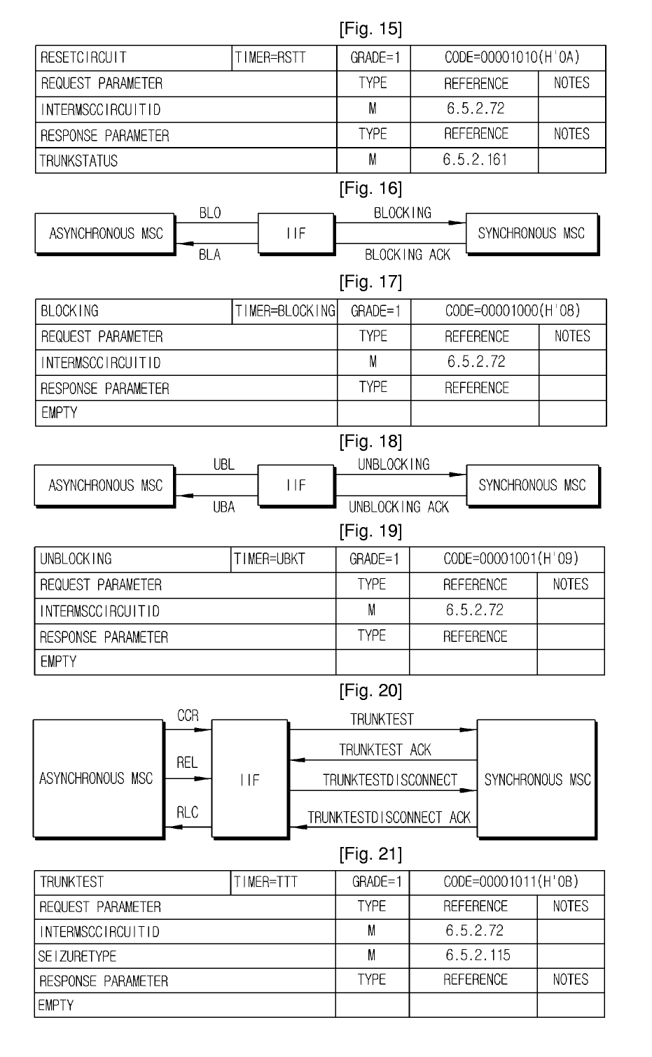

FIGS. 14 and 15 are views for describing the circuit reset message used in the method for managing a trunk line between mobile switching centers according to the second embodiment of the present invention. As shown in FIG. 14, the asynchronous mobile switching center transmits a circuit reset message (RSC) to the IIF unit by using the ISUP protocol when it is necessary to use a trunk line between the asynchronous mobile switching center and the synchronous mobile switching center or in order to reproduce status information of a damaged circuit and reset the damaged circuit. Then, the IIF unit converts the received message into a circuit reset message based on the MAP protocol and transmits the converted circuit reset message (ResetCircuit) to the synchronous switching center.

Upon receiving the MAP protocol-based circuit reset message (ResetCircuit), the synchronous mobile switching center transmits a response message (ResetCircuit Ack) including the status information of the trunk line to the IIF unit. Then, the IIF unit converts the response message (ResetCircuit Ack) into an ISUP protocol-based message (RLC) and transmits it to the asynchronous mobile switching center as a response to the circuit reset message (RSC).

The MAP protocol-based circuit reset message (ResetCircuit) includes a parameter (InterMSCCircuitID) for the internal switching center circuit ID as shown in FIG. 15 and the response message (ResetCircuit Ack) includes a parameter (TrunkState) for the status information of trunk line.

FIGS. 16 through 19 are views for describing a circuit interruption message and a circuit interruption release message used in the method for managing a trunk line between mobile switching centers according to the second embodiment of the present invention.

Referring to FIG. 16, in order to report that the trunk line allocated between the mobile switching centers has been interrupted, that is, when it is unnecessary to maintain the connection between the mobile switching centers any more, the asynchronous mobile switching center transmits an ISUP protocol-based circuit interruption message (BLO) to the IIF unit, and the IIF unit converts the received message into an MAP protocol-based circuit interruption message (Blocking) and transmits the converted message to the synchronous mobile switching center.

Then, the synchronous mobile switching center transmits to the IIF unit an MAP protocol-based response message (Blocking Ack) to the MAP protocol-based circuit interruption message (Blocking). The IIF unit converts the MAP protocol-based response message (Blocking Ack) into a response message (BLA) for the ISUP protocol-based circuit interruption message (BLO) and transmits the converted response message (BLA) to the asynchronous mobile switching center.

Referring to FIG. 18, when the connection between the mobile switching centers has been interrupted by the circuit interruption message (Blocking) of FIG. 16, the asynchronous mobile switching center transmits a circuit reset message (UBL) to the IIF unit by using the ISUP protocol in order to switch the trunk line into a serviceable status again. The IIF unit converts the received message into an MAP protocol-based message (Unblocking) and transmits the converted message to the synchronous mobile switching center.

In response to the received circuit reset message (Unblocking), the synchronous mobile switching center transmits an MAP protocol-based message (Unblocking Ack) to the IIF unit. The IIF unit converts the received message into an ISUP protocol-based message (UBA) and transmits the converted message to the synchronous mobile switching center.

The MAP protocol-based circuit interruption message (Blocking) includes a parameter (InterMSCCircuitID) for the internal switching center circuit ID as shown in FIG. 17 and the MAP protocol-based circuit reset message (Unblocking) also includes a parameter (InterMSCCircuitID) for the internal switching center circuit ID as shown in FIG. 19.

FIGS. 20 through 22 are views for describing a trunk line test message used in the method for managing a trunk line between mobile switching centers according to the second embodiment of the present invention.

As shown in FIG. 20, in order to check if the trunk line exactly operates, the asynchronous mobile switching center transmits a trunk line test message (CCR) to the IIF unit by using the ISUP protocol. The IIF unit converts the received message into an MAP protocol-based message (TrunkTest) and transmits the converted message to the synchronous mobile switching center. Then, the synchronous mobile switching center transmits a response message (TrunkTest Ack) to the IIF unit.

When it is necessary to end the test for the trunk line, the asynchronous mobile switching center transmits an ISUP protocol-based trunk line test release message (REL) to the IIF unit. The IIF unit converts the received message into an MAP protocol-based message (TrunkTestDisconnect) and transmits the converted message to the synchronous mobile switching center.

Upon receiving the trunk test release message (TrunkTestDisconnect), the synchronous mobile switching center transmits a response message (TrunkTestDisconnect Ack) to the IIF unit. The IIF unit converts the received message into an ISUP protocol-based message (RLC) and transmits the converted message to the asynchronous mobile switching center.

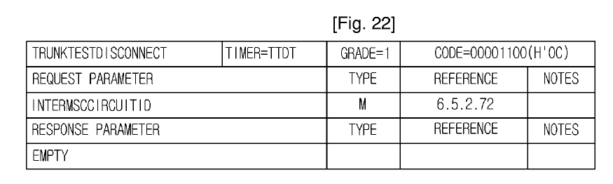

The MAP protocol-based trunk line test message (TrunkTest) includes parameters for the internal switching center circuit ID (InterMSCCircuitID) and the seizure type (SeizureType) as shown in FIG. 21 and the MAP protocol-based trunk line test release message (TrunkTestDisconnect) includes a parameter for the internal switching center circuit ID (InterMSCCircuitID) as shown in FIG. 22.

The above description deals with the case where the trunk line management messages are transmitted from the asynchronous mobile switching center to the synchronous mobile switching center through the IIF unit. However, it is possible to manage the trunk line in the opposite manner in which the synchronous mobile switching center first transmits the trunk line management messages to the asynchronous mobile switching center through the IIF unit and then receives response messages from the synchronous mobile switching center. Further, each of the trunk line management messages may include other parameters in addition to the parameters shown in the drawings according to expansion of functions performed between the mobile switching centers.

### INDUSTRIAL APPLICABILITY

In a method and system according to the present invention, when a dual-mode dual-band mobile communication terminal moves from an area of an asynchronous mobile communication system to an area of a synchronous mobile communication system, trunk line management messages are transmitted/received between an asynchronous mobile switching center and a synchronous mobile switching center in performing the setting, resetting, releasing, retrial and status confirmation of the trunk line, in order to achieve an exact handover. Therefore, the present invention enables messages to be exactly transmitted between the asynchronous mobile switching center and the synchronous mobile switching center, thereby providing a service of an improved quality to a mobile communication terminal without interruption in the service.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A method for management of a trunk line between an asynchronous mobile switching center and a synchronous mobile switching center for handover of a dual-band dual-mode mobile communication terminal capable of communicating with both an asynchronous mobile communication system and a synchronous mobile communication system, the method comprising the steps of:
checking a status of the trunk line between the asynchronous mobile switching center and the synchronous mobile switching center by transmitting/receiving at least one of trunk line management messages between the asynchronous mobile switching center and the synchronous mobile switching center, when the asynchronous mobile switching center and the synchronous mobile switching center are in an invoke state, the trunk line management messages including a circuit reset message, a circuit interruption message and a trunk line test message.

2. The method as claimed in claim 1, wherein the status of the trunk line is confirmed by the synchronous mobile switching center when a trunk line management message has been transmitted from the asynchronous mobile switching center to the synchronous mobile switching center and is confirmed by the asynchronous mobile switching center when the trunk line management message has been transmitted from the synchronous mobile switching center to the asynchronous mobile switching center.

3. The method as claimed in claim 1, wherein the asynchronous mobile switching center transmits a trunk line management message to the synchronous mobile switching center and then receives a response message for the trunk line management message or the synchronous mobile switching center transmits the trunk line management message to the asynchronous mobile switching center and then receives the response message for the trunk line management message.

4. The method as claimed in claim 1, wherein the circuit reset message is transmitted/received between the asynchronous mobile switching center and the synchronous mobile switching center when it is necessary to use a trunk line between the asynchronous mobile switching center and the synchronous mobile switching center or in order to reproduce status information of a damaged circuit and reset the damaged circuit.

5. The method as claimed in claim 3, wherein the circuit reset message includes a parameter (InterMSCCircuitID) of the internal switching center circuit ID and the response message includes a parameter (TrunkState) of the status information of the trunk line.

6. The method as claimed in claim 1, wherein the circuit interruption message is transmitted/received between the asynchronous mobile switching center and the synchronous mobile switching center in order to confirm interruption of a connection between the asynchronous mobile switching center and the synchronous mobile switching center.

7. The method as claimed in claim 1, wherein the circuit interruption message includes a parameter (InterMSCCircuitID) of the internal switching center circuit ID.

8. The method as claimed in claim 1, wherein the trunk line management messages further comprise a circuit interruption release message, and the trunk line is reactivated by the circuit interruption release message when the circuit interruption release message has been transmitted/received between the asynchronous mobile switching center and the synchronous mobile switching center.

9. The method as claimed in claim 1, wherein the trunk line test message is transmitted/received between the asynchronous mobile switching center and the synchronous mobile switching center in order to determine if the trunk line between the asynchronous mobile switching center and the synchronous mobile switching center exactly operates.

10. The method as claimed in claim 1, wherein the trunk line test message includes parameters of an internal switching center circuit ID (InterMSCCircuitID) and a seizure type (SeizureType).

11. The method as claimed in claim 1, wherein the trunk line management messages further comprise a trunk line test release message and a test of the trunk line is completed when the trunk line test release message is transmitted/received between the asynchronous mobile switching center and the synchronous mobile switching center.

12. A method for management of a trunk line between an asynchronous mobile switching center and a synchronous mobile switching center for handover of a dual-band dual-mode mobile communication terminal capable of communicating with both an asynchronous mobile communication system and a synchronous mobile communication system, the method comprising the steps of:
checking a status of the trunk line between the asynchronous mobile switching center and the synchronous mobile switching center by transmitting/receiving at least one of trunk line management messages through an interworking interoperability function unit between the asynchronous mobile switching center and the synchronous mobile switching center, the asynchronous mobile switching center and the synchronous mobile switching center being connected to the interworking interoperability function unit, the trunk line management messages including a circuit reset message, a circuit interruption message and a trunk line test message.

13. The method as claimed in claim 12, wherein the asynchronous mobile switching center and the interworking interoperability function unit exchanges the trunk line management messages based on an ISUP protocol and the asynchronous mobile switching center and the interworking interoperability function unit exchanges the trunk line management messages based on an MAP protocol, in order to check the status of the trunk line between the asynchronous mobile switching center and the synchronous mobile switching center.

14. The method as claimed in claim 12, wherein the status of the trunk line is confirmed by the synchronous mobile switching center when a trunk line management message has been transmitted from the asynchronous mobile switching center to the synchronous mobile switching center through the interworking interoperability function unit and is confirmed by the asynchronous mobile switching center when the trunk line management message has been transmitted from the synchronous mobile switching center to the asynchronous mobile switching center through the interworking interoperability function unit.

15. The method as claimed in claim 12, wherein the asynchronous mobile switching center transmits a trunk line management message to the synchronous mobile switching center through the interworking interoperability function unit and then receives a response message for the trunk line management message, or the synchronous mobile switching center transmits the trunk line management message to the asynchronous mobile switching center through the interworking interoperability function unit and then receives the response message for the trunk line management message.

16. The method as claimed in claim 12, wherein the circuit reset message is transmitted/received between the asynchronous mobile switching center and the synchronous mobile switching center when it is necessary to use a trunk line between the asynchronous mobile switching center and the synchronous mobile switching center or in order to reproduce status information of a damaged circuit and reset the damaged circuit.

17. The method as claimed in claim 16, wherein the circuit reset message includes a parameter (InterMSCCircuitID) of the internal switching center circuit ID and the response message includes a parameter (TrunkState) of the status information of the trunk line.

18. The method as claimed in claim 12, wherein the circuit interruption message is transmitted/received between the asynchronous mobile switching center and the synchronous mobile switching center in order to confirm interruption of a connection between the asynchronous mobile switching center and the synchronous mobile switching center.

19. The method as claimed in claim 12, wherein the circuit interruption message includes a parameter (InterMSCCircuitID) of the internal switching center circuit ID.

20. The method as claimed in claim 12, wherein the trunk line management messages further comprise a circuit interruption release message, and the trunk line is re-activated by the circuit interruption release message when the circuit interruption release message has been transmitted/received between the asynchronous mobile switching center and the synchronous mobile switching center.

21. The method as claimed in claim 12, wherein the trunk line test message is transmitted/received between the asynchronous mobile switching center and the synchronous mobile switching center in order to determine if the trunk line between the asynchronous mobile switching center and the synchronous mobile switching center exactly operates.

22. The method as claimed in claim 12, wherein the trunk line test message includes parameters of an internal switching center circuit ID (InterMSCCircuitID) and a seizure type (SeizureType).

23. A system for management of a trunk line between an asynchronous mobile switching center and a synchronous mobile switching center for handover of a dual-band dual-mode mobile communication terminal in a hybrid mobile communication system including both an asynchronous network and a synchronous network, the system comprising:
the asynchronous mobile switching center for transmitting a trunk line management message to the synchronous mobile switching center and receiving a response message from the synchronous mobile switching center, thereby confirming the status of the trunk line; and
the synchronous mobile switching center for transmitting a trunk line management message to the synchronous mobile switching center and receiving a response message from the synchronous mobile switching center, thereby confirming the status of the trunk line.

24. The system as claimed in claim 23, wherein the trunk line management message comprises at least one of a circuit reset message, a circuit interruption message and a trunk line test message.

25. The system as claimed in claim 24, wherein the circuit reset message is used when it is necessary to use the trunk line between the asynchronous mobile switching center and the synchronous mobile switching center or in order to reproduce status information of a damaged circuit and reset the damaged circuit.

26. The system as claimed in claim 24, wherein the circuit reset message includes a parameter (InterMSCCircuitID) of the internal switching center circuit ID and the response message includes a parameter (TrunkState) of the status information of the trunk line.

27. The system as claimed in claim 24, wherein the circuit interruption message is transmitted/received between the asynchronous mobile switching center and the synchronous mobile switching center in order to confirm interruption of a connection between the asynchronous mobile switching center and the synchronous mobile switching center.

28. The system as claimed in claim 24, wherein the circuit interruption message includes a parameter (InterMSCCircuitID) of the internal switching center circuit ID.

29. The system as claimed in claim 24, wherein the trunk line management messages further comprise a circuit interruption release message, and the trunk line is reactivated by the circuit interruption release message when the circuit interruption release message has been transmitted/received between the asynchronous mobile switching center and the synchronous mobile switching center.

30. The system as claimed in claim 24, wherein the trunk line test message is transmitted/received between the asynchronous mobile switching center and the synchronous mobile switching center in order to determine if the trunk line between the asynchronous mobile switching center and the synchronous mobile switching center exactly operates.

31. The system as claimed in claim 24, wherein the trunk line test message includes parameters of an internal switching center circuit ID (InterMSCCircuitID) and a seizure type (SeizureType).

32. The system as claimed in claim 23, further comprising an interworking interoperability function unit which receives the trunk line management message based on an ISUP protocol from the asynchronous mobile switching center and then transmits the trunk line management message based on an MAP protocol to the synchronous mobile switching center, and receives the trunk line management message based on an MAP protocol from the synchronous mobile switching center and then transmits the trunk line management message based on an ISUP protocol to the asynchronous mobile switching center.
